(19) United States
(12) Patent Application Publication
(10) Pub. No.: US 2026/0326623 A1
(43) Pub. Date: Oct. 22, 2026

(54) VEHICLE

(71) Applicant: KAWASAKI MOTORS, LTD., Akashi-shi (JP)

(72) Inventor: Akihiro FUKUMOTO, Akashi-shi (JP)

(73) Assignee: KAWASAKI MOTORS, LTD., Akashi-shi (JP)

(21) Appl. No.: 19/651,822

(22) Filed: Apr. 20, 2026

(30) Foreign Application Priority Data
Apr. 21, 2025 (JP) 2025-069740

(51) Int. Cl. B60N 2/015

(52) U.S. Cl. CPC B60N 2/01508

(57) ABSTRACT

A vehicle includes a vehicle body and a seat including a backrest including a backrest body, an upper engagement portion in an upper portion of a back surface of the backrest body, a handle in a lower portion of the backrest body, and a lower engagement portion between the upper engagement portion and the handle in a vertical direction on the back surface of the backrest body. The vehicle body includes a receiver including an upper receiver engaged with the upper engagement portion, and a lower receiver engaged with the lower engagement portion. The upper engagement portion is engaged with the upper receiver pivotably about an axis extending in a width direction of the seat. The lower engagement portion is engaged with the lower receiver when the backrest pivots about the axis with the upper engagement portion engaged with the upper receiver.

### CROSS-REFERENCE TO RELATED APPLICATION

The present application claims priority to Japanese Patent Application No. 2025-069740 filed on Apr. 21, 2025, the content of which is incorporated herein by reference.

### BACKGROUND

### Technical Field

The present disclosure relates to a vehicle.

### Description of the Background

Patent Literature 1 describes a multipurpose vehicle. In the multipurpose vehicle described in Patent Literature 1, a backrest is mounted on the vehicle body with a first lock including a hook and a second lock including a fork-shaped portion and located upward from the first lock.

### CITATION LIST

### Patent Literature

Patent Literature 1: U.S. Pat. No. 11,912,169

### BRIEF SUMMARY

The backrests in vehicles are to be easily mounted and removed.

One or more aspects of the present disclosure are directed to a technique for easily mounting and removing a backrest in a vehicle.

In response to the above, a vehicle according to an aspect of the present disclosure includes a vehicle body including a floor and a receiver located upward from the floor, and a seat located on the floor and supported by the vehicle body. The seat includes a seat bottom and a backrest. The backrest includes a backrest body having a front surface to be in contact with an occupant and a back surface opposite to the front surface, an upper engagement portion located in an upper portion of the back surface of the backrest body, a handle located in a lower portion of the backrest body, and a lower engagement portion located between the upper engagement portion and the handle in a vertical direction on the back surface of the backrest body. The receiver includes an upper receiver engaged with the upper engagement portion, and a lower receiver engaged with the lower engagement portion. The upper engagement portion is engaged with the upper receiver in a manner pivotable about an axis extending in a width direction of the seat. The lower engagement portion is engaged with the lower receiver when the backrest pivots about the axis with the upper engagement portion engaged with the upper receiver.

This vehicle allows easy mounting and removal of backrests.

### BRIEF DESCRIPTION OF DRAWINGS

FIG. 1 is a perspective view of a vehicle according to an embodiment.

FIG. 2 is a perspective view of a rear seat of the vehicle and the peripheral portions of the rear seat.

FIG. 3 is a perspective view of a rear portion of the vehicle.

FIG. 4 is a partial cross-sectional view taken along line IV-IV in FIG. 1.

FIG. 5 is a partial cross-sectional view taken along line V-V in FIG. 4.

FIG. 6 is a partial cross-sectional view taken along line VI-VI in FIG. 4.

FIG. 7 is an enlarged view of area R1 in FIG. 6.

FIG. 8 is a perspective view of a rear portion of the vehicle with a first backrest removed.

FIG. 9 is a perspective view of the rear seat.

FIG. 10 is a perspective view of the first backrest.

FIG. 11 is an enlarged view of area R2 in FIG. 10.

FIG. 12 is an enlarged view of area R3 in FIG. 10.

FIG. 13 is a diagram illustrating mounting of the rear seat on a vehicle body.

FIG. 14 is a diagram illustrating mounting of the rear seat on the vehicle body.

### DETAILED DESCRIPTION

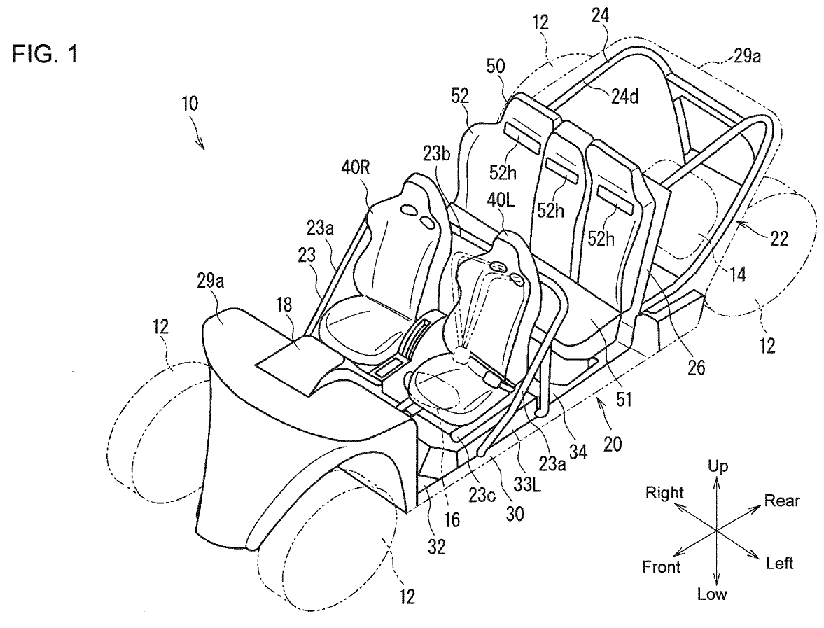

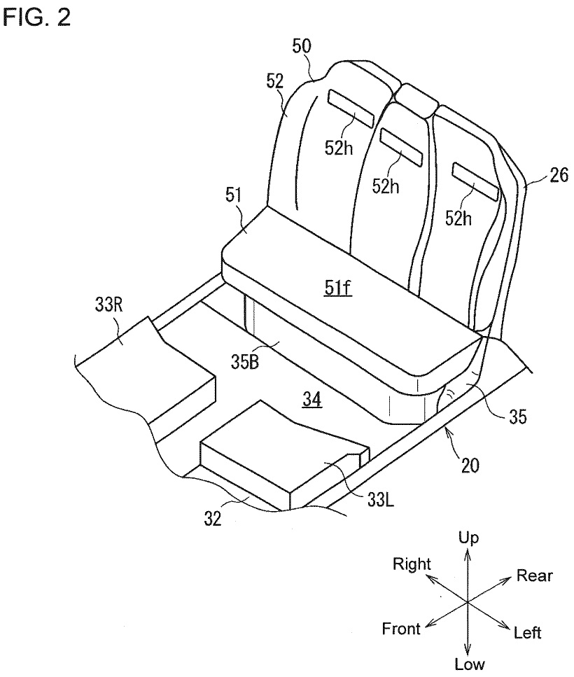

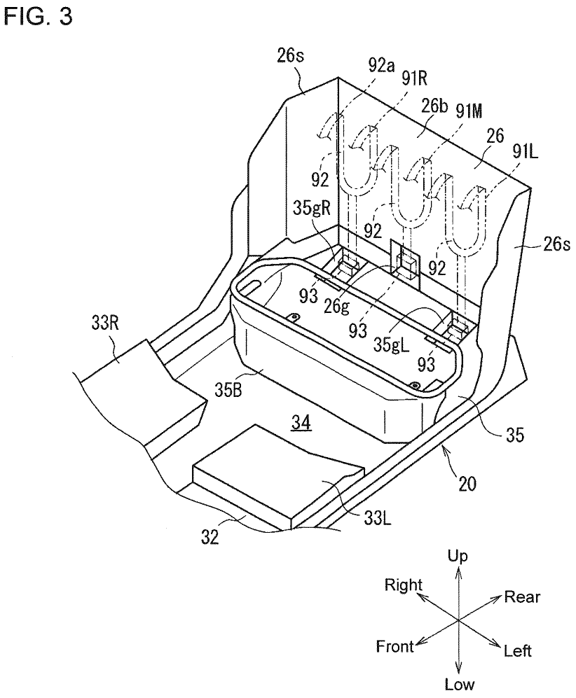

A vehicle according to one or more embodiments will be described below. FIG. 1 is a perspective view of a vehicle 10. FIG. 2 is a perspective view of a rear seat 50 of the vehicle 10 and the peripheral portions of the rear seat 50. FIG. 3 is a perspective view of a rear portion of the vehicle. In FIGS. 2 and 3, front seats 40L and 40R are not shown. In FIG. 3, the rear seat 50 is not shown.

In the examples described below, the traveling direction of the vehicle 10 may be referred to as front, the direction opposite to the traveling direction as rear, the direction in which the traveling surface is located as low, and the direction opposite to the direction in which the traveling surface is located as up. The traveling surface is, for example, the ground or a road. The right and left may be referenced with the vehicle facing forward on the traveling surface. The right-left direction is the width direction of the vehicle.

The vehicle 10 is a conveyance that travels on the traveling surface. The vehicle 10 may be, for example, an off-road vehicle. The off-road vehicle may be a versatile compact vehicle that is more suitable for off-road driving than for public-road driving at high speeds.

The off-road vehicle includes, for example, a side-by-side vehicle. The side-by-side vehicle is, for example, a compact vehicle for all-terrain travel and in which passengers can sit next to each other. The side-by-side vehicle may be, for example, a multipurpose off-highway utility vehicle (MOHUV) as defined by ANSI/OPEI B71.9-2016, or a recreational off-highway vehicle as defined by ANSI/ROHVA 1-2016. In the present embodiment, the off-road vehicle includes the front seats 40L and 40R and the rear seat 50.

The vehicle 10 may be a passenger transport vehicle intended for traveling at low speeds in a limited area.

The limited area may be, for example, a limited community area, a private road, or private land (e.g., a golf course or a park). The limited community area is an area for local residents. The community area includes, for example, multiple houses and public facilities (e.g., schools or hospitals), in which vehicles not intended for public road travel are permitted to travel at low speeds. The low speeds refer to speeds with an upper limit of, for example, 20 to 30 mph. The vehicle 10 includes a personal transport vehicle (PTV) defined by ANSI/ILTVA Z135 and a golf cart defined by ANSI/ILTVA Z130.1. The vehicle 10 also includes a personal transportation electric vehicle.

The vehicle 10 includes a vehicle body 20 and the seats 40L, 40R, and 50. In the present embodiment, the seats 40L, 40R, and 50 are the front seats 40L and 40R and the rear seat 50.

The vehicle body 20 is a support structure that supports the components of the vehicle 10 or supports the occupants or cargo. The vehicle body 20 includes, for example, a frame 22 and a floor 30.

The frame 22 includes, for example, multiple elongated members that are joined together. The elongated members are, for example, metal members. The elongated members may be straight or curved. The elongated members may be pipes, plates, or members with a U-shaped cross section. The multiple elongated members may be joined together by, for example, welding or screwing.

The frame 22, including the multiple elongated members joined together, can extend under the floor 30.

The frame 22 may include a rear frame 24 located behind the rear seat 50. The rear frame 24 located behind the rear seat 50 may support a driving system 14.

The floor 30 is at the bottom of the passenger space. The floor 30 includes surfaces for supporting the feet of the occupants in the vehicle or for the occupants to place their feet when they ride or exit the vehicle. The floor 30 includes a plate extending horizontally. The floor 30 may be a floor board.

In the present embodiment, the vehicle body includes the frame 22 and the floor 30 combined together. The vehicle body may be monocoque.

The floor 30 includes a front floor 32 and an intermediate floor 34. The front floor 32 extends in front of the front seats 40L and 40R in the front-rear direction. The front floor 32 extends horizontally. The occupants of the front seats 40L and 40R can place their feet on the front floor 32. The intermediate floor 34 is located between the front seats 40L and 40R and the rear seat 50 in the front-rear direction. The intermediate floor 34 extends horizontally. The occupants of the rear seat 50 can place their feet on the intermediate floor 34.

The floor 30 may include front-seat bases 33L and 33R protruding upward from the front floor 32 and the intermediate floor 34 between the front floor 32 and the intermediate floor 34. The floor 30 has the front-seat base 33L on the left and the front-seat base 33R on the right. The front-seat base 33R and the front-seat base 33L are spaced from each other in the width direction of the vehicle.

The floor 30 may include a rear-seat base 35 located behind the intermediate floor 34. The rear-seat base 35 protrudes upward from the intermediate floor 34. The rear-seat base 35 is elongated in the width direction of the vehicle.

The vehicle 10 may include wheels 12, the driving system 14, and a steering system.

The wheels 12 are rotatably supported on, for example, the right and left of the front and the rear of the vehicle body 20. The wheels 12 may be supported by the vehicle body 20 with a suspension system. Any number of wheels 12 may be used. For example, the wheels 12 may include a single front wheel 12.

For the off-road vehicle 10, the wheels 12 may include low-pressure tires. Low-pressure tires may be referred to as balloon tires. Low-pressure tires are filled at an upper limit air pressure of, for example, 40 kPa or less. Low-pressure tires deform in response to road surface irregularities, increasing the area of contact with the ground surface. This can improve the off-road capability of the vehicle 10 as compared with vehicles with high-pressure tires.

The driving system 14 causes the vehicle 10 to travel. The driving system 14 is supported by the frame 22. The driving system 14 includes, for example, a motor. For example, the motor is supported by the rear frame 24. The motor may be an internal combustion engine or an electric motor. For example, the rotational shaft of the motor is connected to the shafts of the rear wheels 12 directly or with gears. The rotational driving force of the motor is transmitted to the rear wheels 12, allowing the vehicle 10 to travel. The rotational driving force of the driving system 14 may be transmitted to the front wheels 12. For example, the rotational driving force of the driving system 14 may be transmitted to the front wheels 12 through a drive shaft. When the rotational driving force of the driving system 14 is transmitted to the front and rear wheels 12, the off-road capability of the vehicle 10 improves.

The steering system controls the traveling operations of the vehicle 10. The control targets include, for example, the travel, stop, speed, and traveling direction of the vehicle 10.

The steering system includes, for example, a steering wheel 16 located frontward from the front seats 40L and 40R. The steering wheel 16 is rotatably supported by a steering shaft. The steering wheel 16 is operated to rotate the front wheels 12 about steering axes. The front wheels 12 rotate about the steering axes to change the traveling direction of the vehicle 10.

An instrument panel 18 may be installed frontward from the steering wheel 16. The instrument panel 18 incorporates, for example, a speedometer and a battery level gauge.

The steering system may include control pedals. The control pedals may include, for example, a brake pedal and an accelerator pedal. The starting, accelerating, decelerating, and stopping can be controlled by adjusting the degree of pressing the pedals.

The vehicle 10 may include covers 29a and 29b. The cover 29a covers, for example, the portion of the vehicle body 20 located frontward from the instrument panel 18. The left and right portions of the cover 29a are wheel housings covering the front wheels 12. The cover 29b covers, for example, the rear frame 24. The driving system 14 is housed in the cover 29b. The cover 29b may include a cargo compartment definer forming a cargo compartment.

The vehicle 10 may include doors covering the outer left and right of the front seats 40L and 40R and the front floor 32. The vehicle 10 may include doors covering the outer left and right of the rear seat 50 and the intermediate floor 34. The vehicle 10 may include a roof covering the front seats 40L and 40R and the rear seat 50 from above. The roof may be supported at a position spaced upward from the floor 30 by posts standing from the vehicle body 20.

The front seats 40L and 40R are located rearward from the steering wheel 16 in the front-rear direction. The front seats 40L and 40R are, for example, in the frontmost row in the vehicle body 20. The front seats 40L and 40R may include a left front seat 40L and a right front seat 40R.

In the present embodiment, the left front seat 40L is located in a left portion of the vehicle body 20. The left front seat 40L is located directly behind the steering wheel 16. The left front seat 40L is the driver seat. The right front seat 40R is on the right of the left front seat 40L. The right front seat 40R is a passenger seat. The left front seat 40L and the right front seat 40R are spaced from each other in the width direction of the vehicle.

The left front seat 40L and the right front seat 40R may each include a seat bottom and a backrest. The seat bottom supports the occupant from below. The occupant can sit on the seat bottom. The backrest protrudes upward from the seat bottom behind the seat bottom. The occupant sitting on the seat bottom can lean back on the backrest. The backrest supports the occupant's back from the rear.

The front seats 40L and 40R are supported by the vehicle body 20. For example, the frame 22 includes a front-seat support frame 23. The front-seat support frame 23 includes, for example, a pair of vertical frames 23a extending upward from the left and right of the floor 30, a cross frame 23b connecting the pair of vertical frames 23a, and side frames 23c extending frontward from lower portions of the vertical frames 23a. The backrests of the front seats 40L and 40R may be supported by the cross frame 23b, and the seat bottoms of the front seats 40L and 40R may be supported by the side frames 23c.

The rear seat 50 is supported by the vehicle body 20 rearward from the front seats 40L and 40R. The front seats 40L and 40R are spaced from the rear seat 50 to allow the occupants to place their legs. The rear seat 50 is located, for example, rearward and upward from the intermediate floor 34. The rear seat 50 is located frontward from a partition 26.

The rear seat 50 may include a seat bottom 51 and a backrest 52. The seat bottom 51 supports the occupants from below. The seat bottom 51 has a seat surface 51f extending in the width direction of the vehicle. The seat surface 51f is wide enough to allow multiple occupants to sit side by side. For example, the seat bottom 51 may be wide enough to allow three occupants to sit side by side.

The seat surface 51f may be, for example, at least 1 m wide or at least 1.2 m wide. For example, the seat surface 51f may have a width that is at least 80 percent of the total width of the vehicle body 20.

The backrest 52 protrudes upward from the seat bottom 51 behind the seat bottom 51. The occupant sitting on the seat bottom 51 can lean back on the backrest 52. The backrest 52 supports the occupant's back from the rear. The backrest 52 may be as wide as the seat bottom 51. The backrest 52 may be divided into multiple sections.

The vehicle may further include other seats behind the rear seat 50. For example, the vehicle may include three rows of seats arranged in the front-rear direction.

The vehicle body 20 may include the partition 26 located behind the rear seat 50. The partition 26 separates the occupant space from the cargo bed. The partition 26 is located in front of the rear frame 24. The partition 26 in this example includes a back panel 26b located behind the rear seat 50, and a pair of side panels 26s protruding frontward from the left and right ends of the back panel 26b. The back panel 26b stands upward from the rear end of the rear-seat base 35. The back panel 26b may be tilted, with its upper portion located rearward from its lower portion. The front ends of the side panels 26s are located at the outer ends of the backrest 52 in the width direction of the vehicle. The back panel 26b and the side panels 26s may be separate members. The back panel 26b and the side panels 26s may be a single integral member.

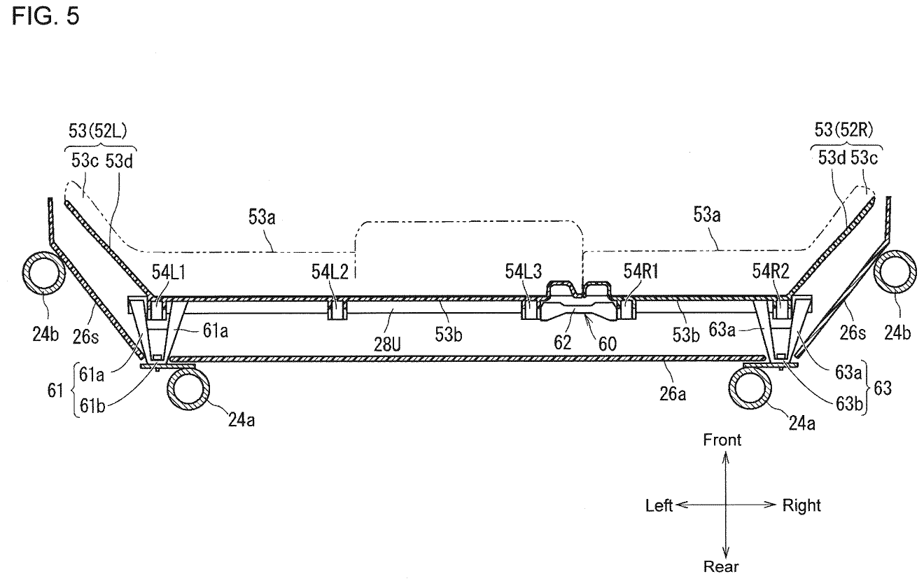

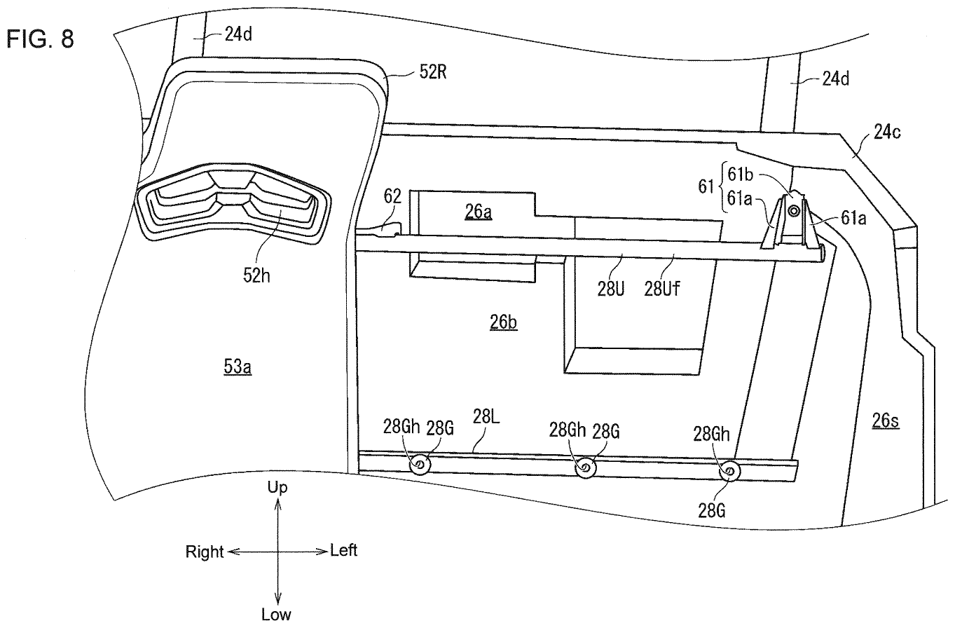

The partition 26 may be supported by the rear frame 24. For example, the front portion of the rear frame 24 includes two pairs of rear vertical frames 24a and 24b (refer to FIG. 5) standing from the floor 30, a rear cross frame 24c (refer to FIG. 8) connecting the two pairs of rear vertical frames, and rear front-rear frames 24d extending rearward from the upper ends of the pair of rear vertical frames 24a. The partition 26 may be connected to the two pairs of rear vertical frames 24a and 24b or the rear cross frame 24c. The pair of rear vertical frames 24b are located frontward from the pair of rear vertical frames 24a and outward from the pair of rear vertical frames 24a in the width direction of the vehicle.

The floor 30 includes the rear-seat base 35 located behind the intermediate floor 34. The rear-seat base 35 protrudes upward from the intermediate floor 34 behind the intermediate floor 34. The rear-seat base 35 may be covered with an under-seat cover 35B from the front. For example, left and right portions of the rear-seat base 35 may each be covered with the under-seat cover 35B.

The intermediate floor 34 extends between the front seats 40L and 40R and the rear seat 50. The middle position of the intermediate floor 34 in the front-rear direction is, for example, the middle position between the boundary between the front-seat bases 33L and 33R and the intermediate floor 34 and the boundary between the rear-seat base 35 and the intermediate floor 34. The front end of the under-seat cover 35B may be located at the boundary between the rear-seat base 35 and the intermediate floor 34.

As shown in FIG. 3, the vehicle 10 may include a rear-seat seatbelt system 90. The rear-seat seatbelt system 90 includes three seatbelt devices 91L, 91M, and 91R. The seatbelt device 91L is for the occupant seated on the left of the rear seat 50. The seatbelt device 91M is for the occupant seated in the middle of the rear seat 50. The seatbelt device 91R is for the occupant seated on the right of the rear seat 50.

Each of the seatbelt devices 91L, 91M, and 91R includes a seatbelt 92 and a retractor 93. The retractor 93 stores a shoulder belt 92a of the seatbelt 92 in an extendable and retractable manner. The shoulder belt 92a extends from the retractor 93, splits in two, and extends frontward out of the backrest 52. The backrest 52 may have through-holes 52h for the shoulder belts 92a to pass through. The two ends of the shoulder belt 92a are detachably connected to a waist belt located in a rear portion of the seat bottom 51 with, for example, a buckle. For example, the occupant seated in the rear seat 50 can wear a four-point seatbelt.

For example, the back panel 26b includes, in a middle portion of its lower portion in the width direction of the vehicle, a recessed portion 26g recessed rearward. The recessed portion 26g receives the retractor 93 of the seatbelt device 91M. For example, the rear-seat base 35 has a left recessed portion 35gL and a right recessed portion 35gR. The left recessed portion 35gL receives the retractor 93 of the seatbelt device 91L. The right recessed portion 35gR receives the retractor 93 of the seatbelt device 91R.

### Rear Seat and Its Peripheral Structure

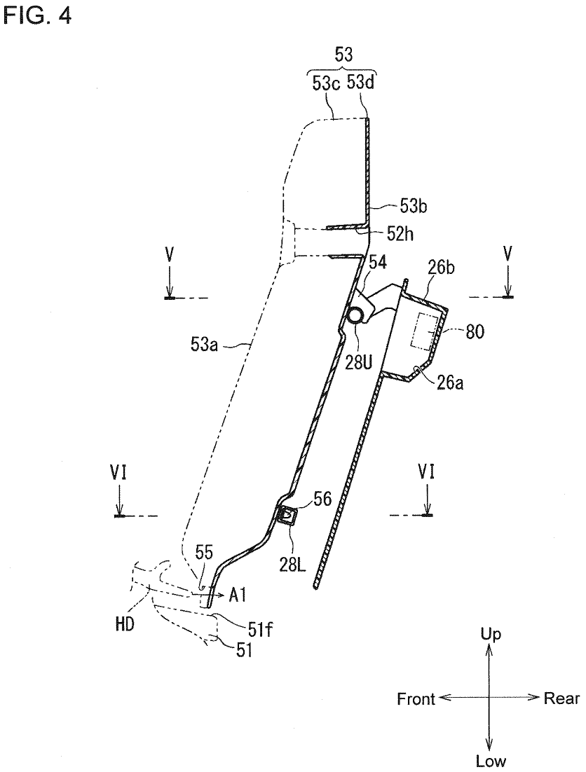

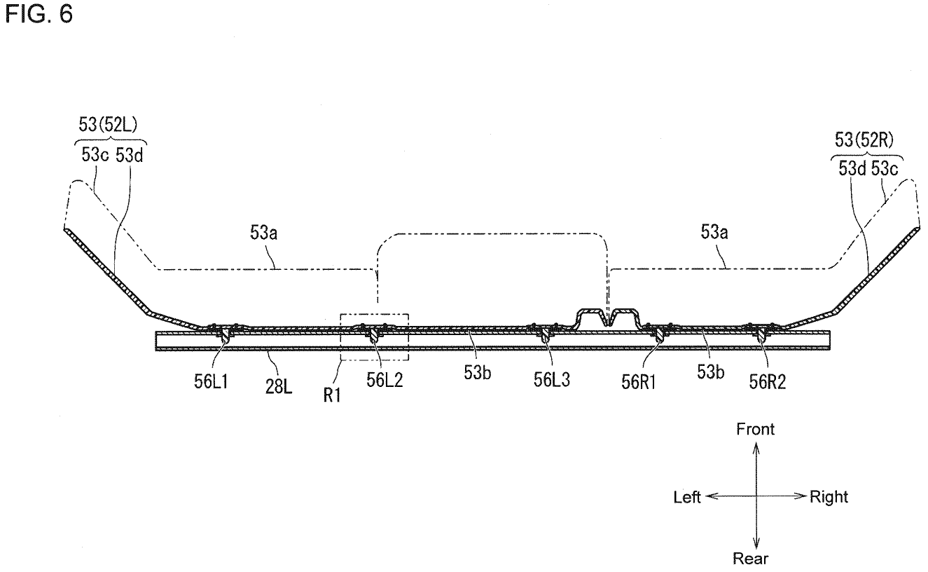

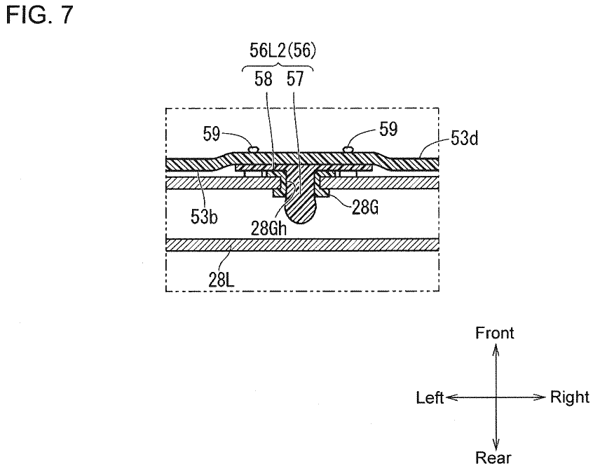

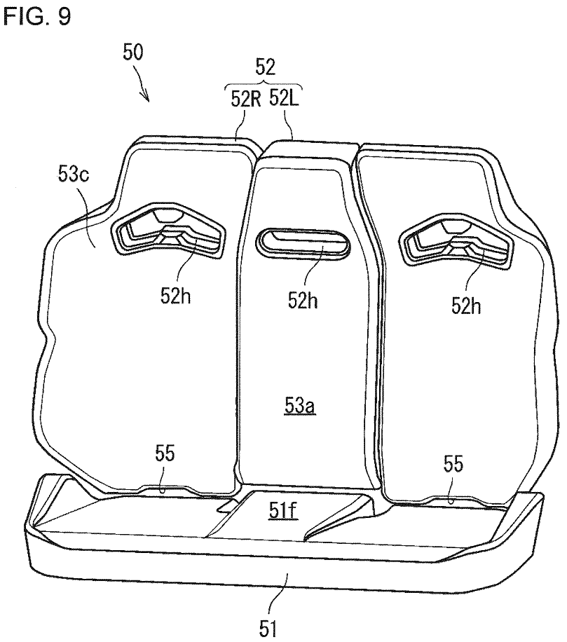

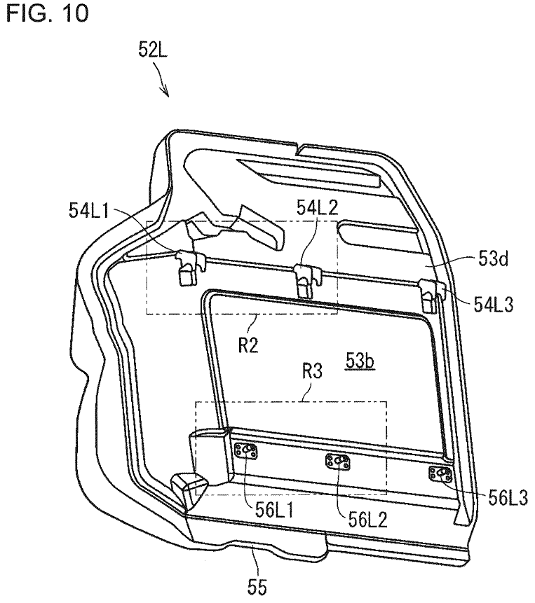

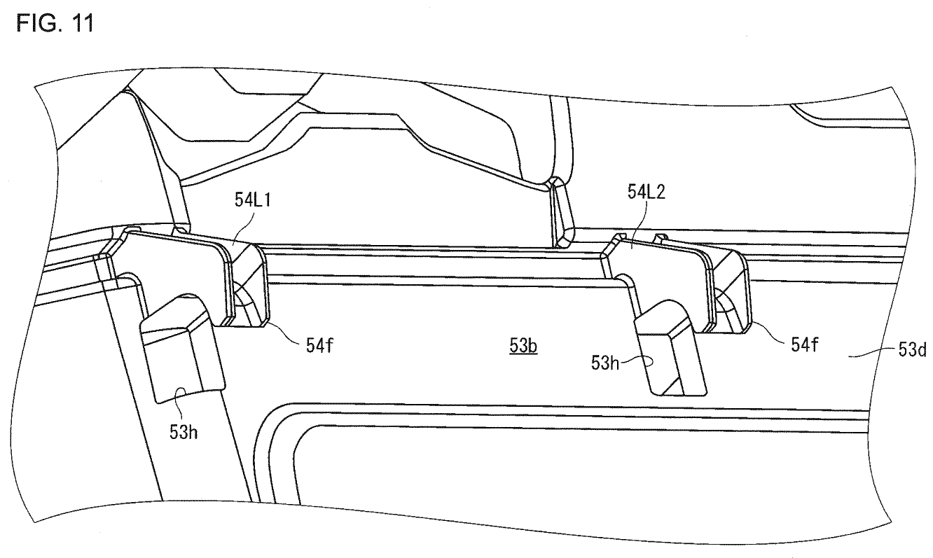

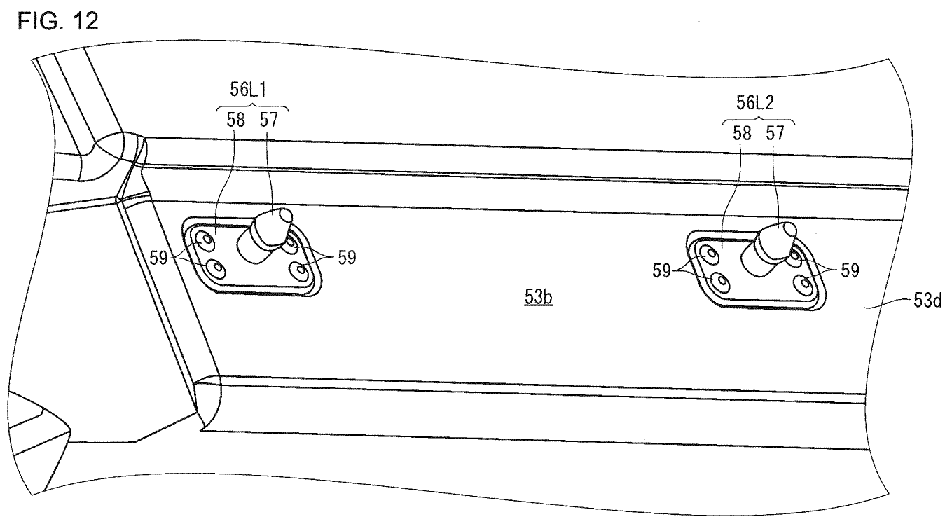

The rear seat of the vehicle 10 and its peripheral structure will now be described with reference to FIGS. 4 to 12. FIG. 4 is a partial cross-sectional view taken along line IV-IV in FIG. 1. FIG. 5 is a partial cross-sectional view taken along line V-V in FIG. 4. FIG. 6 is a partial cross-sectional view taken along line VI-VI in FIG. 4. FIG. 7 is an enlarged view of area R1 in FIG. 6. FIG. 8 is a perspective view of a rear portion of the vehicle 10 with a first backrest 52L removed. FIG. 9 is a perspective view of the rear seat 50. FIG. 10 is a perspective view of the first backrest 52L. FIG. 9 is a front perspective view. FIG. 10 is a rear perspective view. FIG. 11 is an enlarged view of area R2 in FIG. 10. FIG. 12 is an enlarged view of area R3 in FIG. 10.

The frame 22 includes rear-seat support frames 27 and 28. The rear-seat support frames 27 and 28 include a first support frame 27 supporting the seat bottom 51 and second support frames 28 supporting the backrest 52. The first support frame 27 is a rectangular frame. The first support frame 27 is located on the rear-seat base 35. The seat bottom 51 is placed on and fixed to the first support frame 27.

In this example, the second support frames 28 include an upper rod frame 28U and a lower rod frame 28L. The upper rod frame 28U and the lower rod frame 28L each extend in the width direction of the vehicle. The upper rod frame 28U is located upward and rearward from the lower rod frame 28L.

The upper rod frame 28U is connected to, for example, the rear frame 24. The upper rod frame 28U may be connected to, for example, the partition 26. The upper rod frame 28U is a circular pipe.

The lower rod frame 28L is connected to, for example, the partition 26. The lower rod frame 28L may be connected to, for example, the rear frame 24. The lower rod frame 28L is a polygonal pipe. Although the polygonal pipe has four corners in this example, the number of corners may be three or five or more.

The backrest 52 includes a backrest body 53, upper engagement portions 54, handles 55, and lower engagement portions 56. The backrest body 53 has a front surface 53a to be in contact with the occupant, and a back surface 53b opposite to the front surface 53a. The upper engagement portions 54 are located in an upper portion of the back surface 53b of the backrest body 53. The handles 55 are located in a lower portion of the backrest body 53. The lower engagement portions 56 are located between the upper engagement portions 54 and the handles 55 in the vertical direction on the back surface 53b of the backrest body 53.

The vehicle body 20 includes receivers 28Uf and 28G located upward from the floor 30. The partition 26 is located opposite to the backrest body 53 with the receivers 28Uf and 28G located between the partition 26 and the backrest body 53. The receivers 28Uf and 28G include an upper receiver 28Uf and lower receivers 28G. The upper receiver 28Uf is engaged with the upper engagement portions 54. The lower receivers 28G are engaged with the lower engagement portions 56.

The upper engagement portions 54 and the upper receiver 28Uf are engaged with each other in a manner pivotable about an axis extending in the width direction of the seat 50. The lower engagement portions 56 are engaged with the lower receivers 28G when the backrest 52 pivots about the axis with the upper engagement portions 54 engaged with the upper receiver 28Uf. The upper engagement portions 54 and the upper receiver 28Uf are attachable and detachable without any tool. Similarly, the lower engagement portions 56 and the lower receivers 28G are attachable and detachable without any tool.

The upper engagement portions 54 each include a hook 54f protruding from the back surface 53b. The upper receiver 28Uf includes a shaft that pivotally supports each hook 54f. The lower engagement portions 56 each include a pin 57 protruding from the back surface 53b. The lower receivers 28G each have a hole 28Gh receiving the pin 57. For example, the hook 54f may be located upward from the vertically middle position of the backrest 52, and the pin 57 may be located downward from the vertically middle position of the backrest 52. The hook 54f may be located downward from the opening of the through-hole 52h in the back surface 53b. The hook 54f may include a pair of walls and a connecting wall connecting the pair of walls. The hook 54f may have the shape of a gutter.

In this example, the second support frames 28 include the receivers 28Uf and 28G. The upper rod frame 28U includes the upper receiver 28Uf. The upper receiver 28Uf is a portion of the upper rod frame 28U having a circular pipe-shaped outer surface 28Uf. The entire upper receiver 28Uf serves as the shaft.

The lower rod frame 28L includes the lower receivers 28G. The lower rod frame 28L has through-holes through which cylindrical grommets 28G are fitted. Each grommet 28G is cylindrical and is open at both ends. The grommet 28G includes a through-portion extending through the lower rod frame 28L, a first engagement portion located axially in one direction from the through-portion, and a second engagement portion located axially in the other direction from the through-portion. The first engagement portion and the second engagement portion each have a larger outer diameter than the through-portion. The first engagement portion is engaged with the periphery of the through-hole on the inner surface of the lower rod frame 28L. The second engagement portion is engaged with the periphery of the through-hole on the outer surface of the lower rod frame 28L. The grommets 28G serve as the lower receivers 28G. The cylindrical grommets 28G have their shaft holes serving as the holes 28Gh of the lower receivers 28G. The through-holes in the lower rod frame 28L may serve as the holes 28Gh of the lower receivers 28G.

Each handle 55 is a recess. The handle 55 is a portion of the lower edge of the backrest body 53 recessed upward. As indicated by, for example, arrow A1 in FIG. 4, the recess is sized to allow the operator to insert a hand HD into the handle 55. For example, the distance between the seat surface 51f and the lower edge of the backrest body 53 at the position of the handle 55 is greater than or equal to the thickness of an average-sized human hand. For example, the width of the handle 55 is greater than or equal to the width of an average-sized human hand.

In this example, the distance between the handle 55 and the lower engagement portions 56 is shorter than the distance between the lower engagement portions 56 and the upper engagement portions 54 in the vertical direction. More specifically, the lower engagement portions 56 are closer to the handle 55 than to the upper engagement portions 54 in the vertical direction. The distance between the handle 55 and the lower engagement portions 56 may be greater than or equal to the distance between the lower engagement portions 56 and the upper engagement portions 54 in the vertical direction.

The rear seat 50 is a bench seat for multiple occupants to sit side by side in the width direction of the rear seat 50. The rear seat 50 may be a set of separate seats each for a single occupant, similarly to the front seats. The rear seat 50 is a bench seat for three or more occupants to sit side by side in the width direction of the rear seat 50. The backrest 52 includes the first backrest 52L and a second backrest 52R separate from each other in the direction in which the occupants sit side by side. Each of the first backrest 52L and the second backrest 52R includes the upper engagement portions 54, the lower engagement portions 56, and the handle 55.

The first backrest 52L and the second backrest 52R are in contact with each other in the width direction of the vehicle. The seat bottom 51 is undivided. A first seat bottom corresponding to the first backrest 52L and a second seat bottom corresponding to the second backrest 52R are included in the single seat bottom 51. The first seat bottom and the second seat bottom may be separate from each other.

The first backrest 52L is for multiple occupants. When the rear seat 50 is for three occupants, the first backrest 52L is for two occupants. The second backrest 52R is for a single occupant. In the first backrest 52L, a portion of the backrest 52 adjacent to the second backrest 52R is for the middle seat. In this example, the first backrest 52L is located on the left, and the second backrest 52R is located on the right. The first backrest 52L is a single member including a left-seat backrest and a right-seat backrest. The second backrest 52R is a single member including a right-seat backrest alone.

The first backrest 52L includes three upper engagement portions 54L1, 54L2, and 54L3 as the upper engagement portions 54. The three upper engagement portions 54L1, 54L2, and 54L3 are spaced from one another in the width direction of the rear seat 50. The three upper engagement portions 54L1, 54L2, and 54L3 are arranged in this order from the left. The first backrest 52L includes three lower engagement portions 56L1, 56L2, and 56L3 as the lower engagement portions 56. The three lower engagement portions 56L1, 56L2, and 56L3 are spaced from one another in the width direction of the rear seat 50. The three lower engagement portions 56L1, 56L2, and 56L3 are arranged in this order from the left. The upper engagement portion 54L1 and the lower engagement portion 56L1 are located at the end seat. The upper engagement portion 54L3 and the lower engagement portion 56L3 are located in the middle seat.

The first backrest 52L includes the handle 55 in a lower portion of the backrest portion for the end seat. The position of the handle 55 in the width direction of the rear seat 50 may be substantially the same as, for example, the position of the through-hole 52h for the end seat. The position of the handle 55 in the width direction of the rear seat 50 may be substantially the same as, for example, the position of the lower engagement portion 56L1. The position of the handle 55 in the width direction of the rear seat 50 may be, for example, between the upper engagement portions 54L1 and 54L2.

In this example, the seat surface 51f has a portion for the middle seat located higher than a portion for the end seat. The height difference in the seat surface 51f causes the lower edge of the middle seat to be located higher than the lower edge of the end seat in the first backrest 52L. The handle 55 is a portion of the lower edge of the end seat recessed to the height equivalent to the height of the lower edge of the middle seat.

The second backrest 52R includes two upper engagement portions 54R1 and 54R2 as the upper engagement portions 54. The two upper engagement portions 54R1 and 54R2 are spaced from each other in the width direction of the rear seat 50. The two upper engagement portions 54R1 and 54R2 are arranged in this order from the left. The second backrest 52R includes two lower engagement portions 56R1 and 56R2 as the lower engagement portions 56. The two lower engagement portions 56R1 and 56R2 are spaced from each other in the width direction of the rear seat 50. The two lower engagement portions 56R1 and 56R2 are arranged in this order from the left.

The position of the handle 55 in the second backrest 52R may be substantially the same as the position of the through-hole 52h in the width direction of the rear seat 50. The position of the handle 55 in the width direction of the rear seat 50 may be, for example, between the upper engagement portions 54R1 and 54R2. The handle 55 in the first backrest 52L and the handle 55 in the second backrest 52R have the same shape.

The upper engagement portions 54 can be engaged with the upper rod frame 28U at any positions in the direction in which the upper rod frame 28U extends. The upper engagement portions 54 in the first backrest 52L and the upper engagement portions 54 in the second backrest 52R can be engaged with the upper rod frame 28U at any positions in the direction in which the upper rod frame 28U extends.

The vehicle 10 includes restrictors 60. The restrictors 60 restrict the engagement positions of the upper engagement portions 54 with the upper rod frame 28U. The restrictors 60 restrict the engagement positions of the upper engagement portions 54 in the first backrest 52L with the upper rod frame 28U and the engagement positions of the upper engagement portions 54 in the second backrest 52R.

The upper engagement portions 54 in the first backrest 52L include the first upper engagement portions 54L1 and the second upper engagement portions 54L3 spaced from each other in the direction in which the upper rod frame 28U extends. The upper engagement portion 54L3 adjacent to the second backrest 52R of the three upper engagement portions 54L1, 54L2, and 54L3 in the first backrest 52L is an example of the second upper engagement portion 54L3, and the upper engagement portion 54L1 opposite to the upper engagement portion 54L3 is an example of the first upper engagement portion 54L1.

The upper engagement portions 54 in the second backrest 52R include the third upper engagement portions 54R1 and the fourth upper engagement portions 54R2 spaced from each other in the direction in which the upper rod frame 28U extends. The upper engagement portion 54R1 adjacent to the first backrest 52L of the two upper engagement portions 54R1 and 54R2 in the second backrest 52R is an example of the third upper engagement portion 54R1, and the other upper engagement portion 54R2 is an example of the fourth upper engagement portion 54R2.

The restrictors 60 include a first restrictor 62, a second restrictor 61, and a third restrictor 63. The first restrictor 62 restricts the second upper engagement portion 54L3 and the third upper engagement portion 54R1. The second restrictor 61 restricts the first upper engagement portion 54L1. The third restrictor 63 restricts the fourth upper engagement portion 54R2. The first restrictor 62, the second restrictor 61, and the third restrictor 63 are spaced from one another in the direction in which the upper rod frame 28U extends. The first restrictor 62, the second restrictor 61, and the third restrictor 63 are each connected to the upper rod frame 28U. The upper receiver 28Uf is a portion of the upper rod frame 28U not having the first restrictor 62, the second restrictor 61, or the third restrictor 63 on its outer surface 28Uf. The second restrictor 61, the first restrictor 62, and the third restrictor 63 are arranged in this order from the left in the direction in which the upper rod frame 28U extends.

The second restrictor 61 is connected to the left end of the upper rod frame 28U. The second restrictor 61 includes a pair of connecting tabs 61a and a coupling tab 61b. The pair of connection tabs 61a are spaced from each other in the direction in which the upper rod frame 28U extends. The pair of connecting tabs 61a are connected to the upper rod frame 28U. The first upper engagement portion 54L1 is located between the pair of connecting tabs 61a. The pair of connecting tabs 61a protrude rearward from the upper rod frame 28U. The coupling tab 61b couples the distal ends of the pair of connecting tabs 61a. The coupling tab 61b is located rearward from the upper rod frame 28U.

The first restrictor 62 is connected to a middle portion of the upper rod frame 28U in the extending direction. The first restrictor 62 includes, for example, a pair of connecting tabs and a coupling tab coupling the pair of connecting tabs. The first restrictor 62 is longer than the second restrictor 61 in the direction in which the rod frame 28U extends. The second upper engagement portion 54L3 is positioned at the left end of the first restrictor 62. The third upper engagement portion 54R1 is positioned at the right end of the first restrictor 62.

The third restrictor 63 is connected to the right end of the upper rod frame 28U. The third restrictor 63 includes a pair of connecting tabs 63a and a coupling tab 63b. The pair of connection tabs 63a are spaced from each other in the direction in which the upper rod frame 28U extends. The pair of connecting tabs 63a are connected to the upper rod frame 28U. The fourth upper engagement portion 54R2 is located between the pair of connecting tabs 63a. The pair of connecting tabs 63a protrude rearward from the upper rod frame 28U. The coupling tab 63b couples the distal ends of the pair of connecting tabs 63a. The coupling tab 63b is located rearward from the upper rod frame 28U.

In this example, the coupling tab 61b in the second restrictor 61 and the coupling tab 63b in the third restrictor 63 are each connected to the rear frame 24. The coupling tab 61b is fastened to a bracket extending from the left rear vertical frame 24a. The coupling tab 63b is fastened to a bracket extending from the right rear vertical frame 24a. The second restrictor 61 and the third restrictor 63 also serve as brackets to fix the upper rod frame 28U to the vehicle body 20.

The distance between the first upper engagement portion 54L1 and the second upper engagement portion 54L3 may be smaller than the distance between the second restrictor 61 and the first restrictor 62 in the direction in which the upper rod frame 28U extends. The first backrest 52L may be slightly movable in the direction in which the upper rod frame 28U extends, with the first upper engagement portion 54L1 and the second upper engagement portion 54L3 being positioned by the second restrictor 61 and the first restrictor 62. The lower engagement portions 56 and the lower receivers 28G may have guiding shapes that allow such movement. For example, the openings of the holes 28Gh or the distal ends of the pins 57 may serve as guide surfaces. The lower engagement portions 56 may be engageable with the lower receivers 28G when the first backrest 52L is at either the left end or the right end of the range in which the first backrest 52L is movable in the direction in which the upper rod frame 28U extends.

A portion of the backrest body 53 including the back surface 53b and the upper engagement portions 54 are included in a single resin member 53d. For example, the backrest body 53 may include a front member 53c with the front surface 53a and the resin member 53d with the back surface 53b. The front member 53c may be softer than the resin member 53d. The front member 53c may be formed from, for example, a cushioning material. The resin member 53d may be a rigid member that supports the cushioning material. The backrest body 53 may include a single member having the front surface 53a and the back surface 53b.

The resin member 53d may have through-holes 53h at the positions facing the hooks 54f. When the resin member 53d is molded, the portions of the mold to form the hooks 54f are vertically releasable.

The lower engagement portions 56 are separate from the resin member 53d. The backrest 52 includes mount members 59. The mount members 59 attach the lower engagement portions 56 to the resin member 53d. Each lower engagement portion 56 includes the pin 57 and a flange 58 extending from the basal end of the pin 57. The mount members 59 may attach the flange 58 to the resin member 53d. The mount members 59 may be fasteners such as rivets and bolts. In this example, the mount members 59 are located at four positions around each pin 57.

For example, the resin member 53d may be formed from polypropylene (PP), and the lower engagement portions 56 may be formed from nylon. This increases the rigidity of the lower engagement portions 56.

The partition 26 has a storage 26a on its surface facing the backrest body 53 to receive a device 80. In this example, the storage 26a is formed on the front surface 53a of the back panel 26b. The device 80 stored in the storage 26a may be of any type, such as an electrical device for driving the vehicle 10 or for use in the vehicle 10. The electrical device may be, for example, a power box, a fuse box, or an electronic control unit (ECU). The device 80 may be an optional device or an accessory device. The backrest body 53 serves as a cover closing the storage 26a.

### Mounting Method

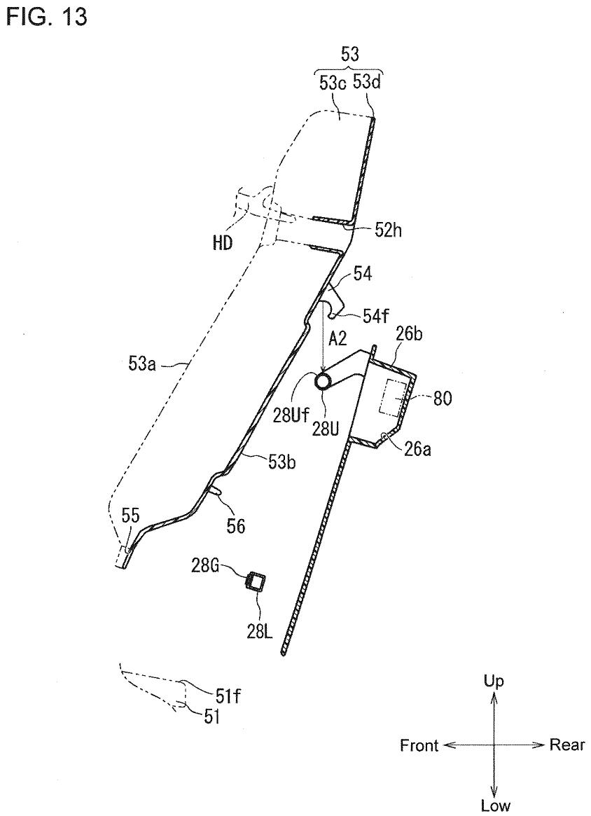

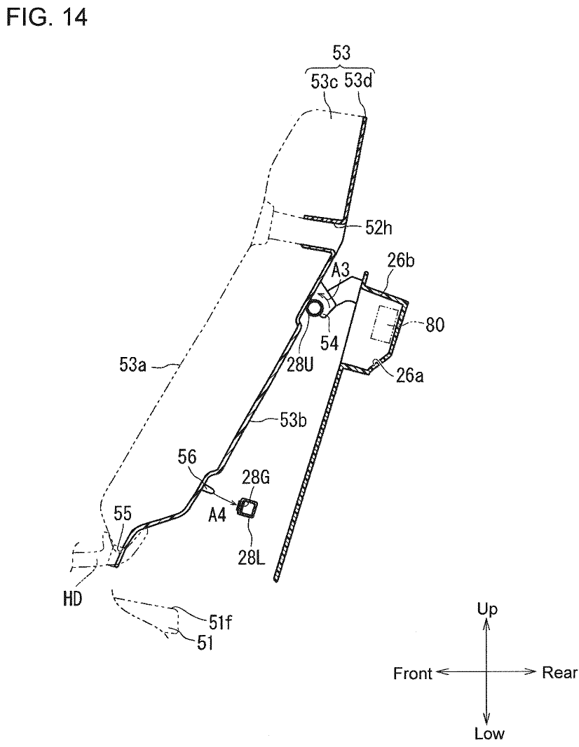

FIGS. 13 and 14 are diagrams illustrating mounting of the backrest 52 on the vehicle body 20.

To mount the backrest 52 on the vehicle body 20, the operator first engages the upper engagement portions 54 with the upper receiver 28Uf as shown in FIG. 13. For example, the backrest 52 is lowered in the direction indicated by arrow A2, with each upper engagement portion 54 located above the upper receiver 28Uf. This causes the hooks 54f in the upper engagement portions 54 to hook on the outer surface 28Uf of the upper rod frame 28U. The upper engagement portions 54 are thus engaged with the upper receiver 28Uf. During this operation, the operator may hold any position of the backrest 52. For example, the operator may hold the backrest 52 by placing their hand into the through-hole 52h in the backrest 52.

Before the backrest 52 is lowered, the upper engagement portions 54 are aligned, in the direction in which the upper rod frame 28U extends, at positions corresponding to the positions of the restrictors 60. For the first backrest 52L, the hook 54f in the first upper engagement portion 54L1 is positioned to be between the pair of connecting tabs 61a in the second restrictor 61. For the second backrest 52R, the hook 54f in the fourth upper engagement portion 54R2 is positioned to be between the pair of connecting tabs 63a in the third restrictor 63.

After the upper engagement portions 54 and the upper receiver 28Uf are engaged with each other, the operator then moves the backrest 52 pivotally as shown in FIG. 14 to engage the lower engagement portions 56 with the lower receivers 28G. With the upper engagement portions 54 engaged with the upper receiver 28Uf, the backrest 52 can pivot about the engaged portion in the direction indicated by arrow A3. When the center of gravity of the backrest 52 and the upper engagement portion 54 are in some positional relationship, for example, the backrest 52 may naturally start pivoting in the direction of arrow A3 due to its weight without any force being applied. The pivot motion moves the pins 57 in the direction indicated by arrow A4. For example, when the backrest 52 is rotated with a weak force, the pivot motion of the backrest 52 stops with the pins 57 in front of the holes 28Gh. In this state, the backrest 52 may be pushed to push the pins 57 into the holes 28Gh. This engages the lower engagement portions 56 with the lower receivers 28G. The operator may hold any position of the backrest 52 in this operation. For example, the operator may hold the backrest 52 by placing their hand into the handle 55.

The backrest 52 is removable from the vehicle body 20 by performing the mounting procedure in the opposite order. In other words, the operator pulls the lower portion of the backrest 52 forward in the state shown in FIG. 4. This disengages the lower engagement portions 56 from the lower receivers 28G. The operator may hold any position of the backrest 52 in this operation. For example, the operator may hold the backrest 52 by placing their hand into the handle 55.

When the lower engagement portions 56 are disengaged from the lower receivers 28G, the operator lifts the backrest 52. This disengages the upper engagement portions 54 from the upper receiver 28Uf. The operator may hold any position of the backrest 52 in this operation. For example, the operator may hold the backrest 52 by placing their hand into the through-hole 52h in the backrest 52.

Either the first backrest 52L or the second backrest 52R may be mounted or removed first. The first backrest 52L and the second backrest 52R are mounted or removed independently of each other. More specifically, the first backrest 52L can be mounted on or removed from the vehicle body 20 with the second backrest 52R mounted or not mounted on the vehicle body 20. Similarly, the second backrest 52R can be mounted on or removed from the vehicle body 20 with the first backrest 52L mounted or not mounted on the vehicle body 20.

The backrest 52 may be mounted or removed by, for example, the operator on the intermediate floor 34. In this case, when the operator mounts the first backrest 52L or the second backrest 52R with neither of the first backrest 52L nor the second backrest 52R mounted on the vehicle body 20, the operator can perform the mounting while visually observing, of the upper rod frame 28U and the lower rod frame 28L, the frame for which the mounting operation is not performed. This allows easy identification of the mount positions in the width direction and the vertical direction. To mount one of the first backrest 52L or the second backrest 52R with the other of them mounted on the vehicle body 20, the operator may have difficulty in visually observing the upper rod frame 28U and the lower rod frame 28L. In this case as well, the operator can identify the approximate mount positions in the width direction and the vertical direction using the backrest mounted on the vehicle body 20 as a reference.

### Effects and Others

The vehicle 10 with the above structure allows the operator to hold the handle 55 when moving the backrest 52 pivotally relative to the vehicle body 20 during mounting or removing of the backrest 52. This allows the operator to easily move the backrest 52 pivotally. The pivotable upper engagement portions 54 and the handle 55 are vertically apart from each other on the backrest 52. This allows the operator pivotally moving the backrest 52 to efficiently transmit the force through the handle 55. The backrest 52 can thus be mounted or removed easily.

The pivotable engagement portions 54 are located upward and the engagement portions 56 engageable through the pivot motion are located downward. This positioning reduces accidental disengagement of the seat 50, compared with the positioning in which the pivotable engagement portions are located downward and the engagement portions engageable through pivot motion are located upward. More specifically, the upper portion of the seat 50 is more susceptible to frontward pushing forces than the lower portion of the seat 50. Examples of the forces pushing the upper portion of the seat 50 frontward include the force from the occupant holding the upper portion of the seat and the force from a cargo on the bed behind the seat 50 pushing the seat 50. When the pivotable engagement portions are located downward and the engagement portions engageable through the pivot motion are located upward, such forces pushing the upper portion of the seat 50 frontward can disengage the engagement portions engaged through pivot motion.

The first backrest 52L and the second backrest 52R each include the upper engagement portions 54, the lower engagement portions 56, and the handle 55. This facilitates mounting and removal of the seat 50 for multiple occupants.

The first backrest 52L is for multiple occupants. This facilitates mounting and removal of the seat 50 for three or more occupants.

The vehicle 10 includes the restrictors 60 that restrict the engagement positions of the upper engagement portions 54 with the upper rod frame 28U. This reduces misalignment of the backrest 52 with the upper rod frame 28U.

The restrictors 60 restrict the engagement positions of the upper engagement portions 54 in the first backrest 52L with the upper rod frame 28U and the engagement positions of the upper engagement portions 54 in the second backrest 52R with the upper rod frame 28U. This reduces misalignment of the first backrest 52L and the second backrest 52R with the upper rod frame 28U.

The restrictors 60 include the first restrictor 62 that restricts the engagement positions of the second upper engagement portion 54L3 and the third upper engagement portion 54R1. The single restrictor 62 can restrict the engagement position of the second upper engagement portion 54L3 in the first backrest 52L and the engagement position of the third upper engagement portion 54R1 in the second backrest 52R. The restrictor 60 further includes the second restrictor 61 that restricts the engagement position of the first upper engagement portion 54L1 and the third restrictor 63 that restricts the engagement position of the fourth upper engagement portion 54R2. The three restrictors 60 can thus restrict the positions of the four upper engagement portions 54.

The vehicle body 20 includes the upper rod frame 28U including the upper receiver 28Uf, and the lower rod frame 28L including the lower receivers 28G. This allows the backrest 52 to be engaged with the upper rod frame 28U and the lower rod frame 28L.

A portion of the backrest body 53 including the back surface 53b and the upper engagement portions 54 are included in the single resin member 53d. The lower engagement portions 56 are separate from the resin member 53d. The backrest 52 includes the mount members 59 attaching the lower engagement portions 56 to the resin member 53d. This allows the upper engagement portions 54 and the lower engagement portions 56 to be formed from different materials.

The backrest body 53 in the first backrest 52L serves as the cover for closing the storage 26a on the partition 26. This allows access to the device 80 by removing the first backrest 52L. Easy mounting and removal of the first backrest 52L allows easy access to the device 80. The storage 26a is at the position corresponding to the first backrest 52L for multiple occupants. The storage 26a can thus be larger easily.

The upper engagement portions 54 each include the hook 54f protruding from the back surface 53b. The upper receiver 28Uf includes the shaft that pivotally supports the hook 54f. This simple structure achieves pivotable engagement of the upper engagement portions 54 with the upper receiver 28Uf. The lower engagement portions 56 each include the pin 57 protruding from the back surface 53b. The lower receivers 28G each have the hole 28Gh receiving the pin 57. Thus, the pins 57 may be placed into or removed from the holes 28Gh to engage or disengage the lower engagement portions 56 with or from the lower receivers 28G.

### Modifications

The components described in the above embodiments and modifications may be combined as appropriate unless any contradiction arises.

Aspects in the specification and drawings herein are provided below.

A vehicle according to a first aspect includes a vehicle body including a floor and a receiver located upward from the floor, and a seat located on the floor and supported by the vehicle body. The seat includes a seat bottom and a backrest. The backrest includes a backrest body having a front surface to be in contact with an occupant and a back surface opposite to the front surface, an upper engagement portion located in an upper portion of the back surface of the backrest body, a handle located in a lower portion of the backrest body, and a lower engagement portion located between the upper engagement portion and the handle in a vertical direction on the back surface of the backrest body. The receiver includes an upper receiver engaged with the upper engagement portion, and a lower receiver engaged with the lower engagement portion. The upper engagement portion is engaged with the upper receiver in a manner pivotable about an axis extending in a width direction of the seat. The lower engagement portion is engaged with the lower receiver when the backrest pivots about the axis with the upper engagement portion engaged with the upper receiver.

The structure according to the first aspect allows the operator to hold the handle when moving the backrest pivotally relative to the vehicle body during mounting or removing of the backrest. This allows the operator to easily move the backrest pivotally. The pivotable upper engagement portion and the handle are vertically apart from each other. This allows the operator pivotally moving the backrest to efficiently transmit the force through the handle. The backrest can thus be mounted and removed easily.

A vehicle according to a second aspect is the vehicle according to the first aspect in which the seat is a bench seat for a plurality of occupants to sit side by side in the width direction. The backrest includes a first backrest and a second backrest separate from each other in a direction in which occupants sit side by side. Each of the first backrest and the second backrest includes the upper engagement portion, the lower engagement portion, and the handle. This facilitates mounting and removal of the seat for multiple occupants.

A vehicle according to a third aspect is the vehicle according to the second aspect in which the seat is a bench seat for three or more occupants to sit side by side in the width direction. The first backrest is for a plurality of occupants. This facilitates mounting and removal of the seat for three or more occupants.

A vehicle according to a fourth aspect is the vehicle according to any one of the first to third aspects in which the vehicle body includes an upper rod frame including the upper receiver. The vehicle includes a restrictor that restricts an engagement position of the upper engagement portion with the upper rod frame. This reduces misalignment of the backrest with the upper rod frame.

A vehicle according to a fifth aspect is the vehicle according to the second aspect or the third aspect in which the vehicle body includes an upper rod frame including the upper receiver. The vehicle includes a restrictor that restricts an engagement position of the upper engagement portion of the first backrest with the upper rod frame and an engagement position of the upper engagement portion of the second backrest with the upper rod frame. This reduces misalignment of the first backrest and the second backrest with the upper rod frame.

A vehicle according to a sixth aspect is the vehicle according to the fifth aspect in which the upper engagement portion of the first backrest includes a first upper engagement portion and a second upper engagement portion spaced from each other in a direction in which the upper rod frame extends. The upper engagement portion of the second backrest includes a third upper engagement portion and a fourth upper engagement portion spaced from each other in the direction in which the upper rod frame extends. The restrictor includes a first restrictor that restricts an engagement position of the second upper engagement portion and an engagement position of the third upper engagement portion. The single restrictor can restrict the engagement position of the second upper engagement portion of the first backrest and the engagement position of the third upper engagement portion of the second backrest.

A vehicle according to a seventh aspect is the vehicle according to the sixth aspect in which the restrictor includes a second restrictor that restricts an engagement position of the first upper engagement portion, and a third restrictor that restricts an engagement position of the fourth upper engagement portion. The three restrictors can thus restrict the positions of the four upper engagement portions.

A vehicle according to an eighth aspect is the vehicle according to any one of the first to seventh aspects in which the vehicle body includes an upper rod frame including the upper receiver, and a lower rod frame including the lower receiver. This allows the backrest to be engaged with the upper rod frame and the lower rod frame.

A vehicle according to a ninth aspect is the vehicle according to any one of the first to eighth aspects in which a portion of the backrest body including the back surface and the upper engagement portion are included in a single resin member. The lower engagement portion is separate from the single resin member. The backrest includes a mount member attaching the lower engagement portion to the single resin member. This allows the upper engagement portion and the lower engagement portion to be formed from different materials.

A vehicle according to a tenth aspect is the vehicle according to the third aspect in which the vehicle body includes a partition located opposite to the backrest body with the receiver located between the partition and the backrest body. The partition includes a storage storing a device on a surface of the partition facing the backrest body of the first backrest. This allows access to the device by removing the backrest. Easy mounting and removal of the backrest allows easy access to the device. The storage is at the position corresponding to the first backrest for multiple occupants. The storage can thus be larger easily.

A vehicle according to an eleventh aspect is the vehicle according to any one of the first to tenth aspects in which the upper engagement portion includes a hook protruding from the back surface. The upper receiver includes a shaft supporting the hook pivotally. The lower engagement portion includes a pin protruding from the back surface. The lower receiver has a hole receiving the pin. This simple structure achieves pivotable engagement of the upper engagement portion with the upper receiver. The pin may be placed into or removed from the hole to engage or disengage the lower engagement portion with or from the lower receiver.

The foregoing discussion is illustrative in all respects, and the invention is not limited to the above structures. Numerous modifications that are not described above may be implemented without deviating from the scope of the present invention.

What is claimed is:

1. A vehicle, comprising:
a vehicle body including a floor and a receiver located upward from the floor; and
a seat located on the floor and supported by the vehicle body,
wherein the seat includes a seat bottom and a backrest,
the backrest includes
a backrest body having a front surface to be in contact with an occupant and a back surface opposite to the front surface,
an upper engagement portion located in an upper portion of the back surface of the backrest body,
a handle located in a lower portion of the backrest body, and
a lower engagement portion located between the upper engagement portion and the handle in a vertical direction on the back surface of the backrest body,
the receiver includes an upper receiver engaged with the upper engagement portion, and a lower receiver engaged with the lower engagement portion,
the upper engagement portion is engaged with the upper receiver in a manner pivotable about an axis extending in a width direction of the seat, and
the lower engagement portion is engaged with the lower receiver when the backrest pivots about the axis with the upper engagement portion engaged with the upper receiver.

2. The vehicle according to claim 1, wherein
the seat is a bench seat for a plurality of occupants to sit side by side in the width direction,
the backrest includes a first backrest and a second backrest separate from each other in a direction in which occupants sit side by side, and
each of the first backrest and the second backrest includes the upper engagement portion, the lower engagement portion, and the handle.

3. The vehicle according to claim 2, wherein
the seat is a bench seat for three or more occupants to sit side by side in the width direction, and
the first backrest is for a plurality of occupants.

4. The vehicle according to claim 1, wherein
the vehicle body includes an upper rod frame including the upper receiver, and
the vehicle comprises a restrictor configured to restrict an engagement position of the upper engagement portion with the upper rod frame.

5. The vehicle according to claim 2, wherein
the vehicle body includes an upper rod frame including the upper receiver, and
the vehicle comprises a restrictor configured to restrict an engagement position of the upper engagement portion of the first backrest with the upper rod frame and an engagement position of the upper engagement portion of the second backrest with the upper rod frame.

6. The vehicle according to claim 5, wherein
the upper engagement portion of the first backrest includes a first upper engagement portion and a second upper engagement portion spaced from each other in a direction in which the upper rod frame extends,
the upper engagement portion of the second backrest includes a third upper engagement portion and a fourth upper engagement portion spaced from each other in the direction in which the upper rod frame extends, and
the restrictor includes a first restrictor configured to restrict an engagement position of the second upper engagement portion and an engagement position of the third upper engagement portion.

7. The vehicle according to claim 6, wherein
the restrictor includes a second restrictor configured to restrict an engagement position of the first upper engagement portion, and a third restrictor configured to restrict an engagement position of the fourth upper engagement portion.

8. The vehicle according to claim 1, wherein
the vehicle body includes an upper rod frame including the upper receiver, and a lower rod frame including the lower receiver.

9. The vehicle according to claim 1, wherein
a portion of the backrest body including the back surface and the upper engagement portion are included in a single resin member,
the lower engagement portion is separate from the single resin member, and
the backrest includes a mount member attaching the lower engagement portion to the single resin member.

10. The vehicle according to claim 3, wherein
the vehicle body includes a partition located opposite to the backrest body with the receiver located between the partition and the backrest body, and
the partition includes a storage storing a device on a surface of the partition facing the backrest body of the first backrest.

11. The vehicle according to claim 1, wherein
the upper engagement portion includes a hook protruding from the back surface, and the upper receiver includes a shaft supporting the hook pivotally, and
the lower engagement portion includes a pin protruding from the back surface, and the lower receiver has a hole receiving the pin.
